(19) United States
(12) Patent Application Publication
(10) Pub. No.: US 2022/0255166 A1
(43) Pub. Date: Aug. 11, 2022

(54) COOLING DEVICE OF AN ELECTRICAL STORAGE SYSTEM AND METHOD USING THE COOLING DEVICE

(71) Applicant: Valeo Systemes Thermiques, Le Mesnil Saint Denis (FR)

(72) Inventors: Amrid Mammeri, Le Mesnil Saint Denis Cedex (FR); Kamel Azzouz, Le Mesnil Saint Denis Cedex (FR); Sébastien Garnier, Le Mesnil Saint Denis Cedex (FR)

(73) Assignee: Valeo Systemes Thermiques, Le Mesnil Saint-Denis (FR)

(21) Appl. No.: 17/611,060

(22) PCT Filed: May 12, 2020
(86) PCT No.: PCT/EP2020/063230

§ 371 Date: Nov. 12, 2021

(30) Foreign Application Priority Data
May 15, 2019 (FR) FR1905092

(51) Int. Cl. H01M 10/6569; H01M 10/613; H01M 10/625; H01M 10/6557

(52) U.S. Cl. CPC H01M 10/6569; H01M 10/613; H01M 2220/20; H01M 10/6557; H01M 10/625

(57) ABSTRACT

The invention relates to a cooling device (2) of a plurality of battery elements (103) of a motor vehicle, wherein the cooling device (2) comprises a first housing accommodating a plurality of battery element stages (103), each battery element stage (103) being equipped with a condenser (3) provided with a cooling fluid circuit (4), the condenser (3) being associated with at least one dielectric fluid circuit (5) that is configured to project a dielectric fluid onto the battery elements (103) of a same stage and a recovery tank (108) of the dielectric fluid that is common to the plurality of battery element stages (103), the cooling device (2) comprising recirculation means (117) of the dielectric fluid, which are provided with a pump (115) and which connect the recovery tank (108) to a dielectric fluid inlet (23) which the dielectric fluid circuit (5) comprises.

The present invention is in the field of heat treatment devices for electrical storage systems of a motor vehicle, and more specifically relates to a device for cooling battery elements that are liable to heat up. The subject matter of the invention is also a method implementing the cooling device.

In the field of motor vehicles, heat treatment devices allow a temperature of an electric battery to be modified, and in particular allow the temperature of the electric battery, which tends to heat up during its use, to be reduced. In general, such heat treatment devices for electric batteries use heat exchangers. The various battery cells of an electrical storage system in particular can be cooled by means of a cold plate, inside which a coolant circulates, with the plate being in contact with the battery cells to be cooled. It has been noted that such heat exchangers can lead to non-homogeneous cooling of the electric batteries of the same electrical storage system, which then results in a reduction in the performance capabilities of these electric batteries. These heat treatment devices also exhibit high thermal resistance due to the thicknesses of material present between the coolant and the battery cells, with the other parameter that contributes to the high thermal resistance being the contact between the cooling plates, the thermal interfaces (PAD) and the surfaces of the cells.

In order to provide a response to these different problems, several devices are known.

In particular, document FR 3037727 is known, which discloses a device for cooling the electric batteries of electric or hybrid cars. More specifically, this document relates to a device for cooling the cells of the electric batteries of a lithium-ion type battery pack. It comprises a hermetically sealed housing, in which a two-phase fluid circulates, and which has an air layer. The electrical storage cells are partially immersed in the two-phase fluid in order to ensure the heat exchange between the cells and the two-phase fluid. Thus, the electric batteries are cooled by immersing the cells of the electric batteries in said fluid. The reserve of two-phase liquid comprises a tank located outside the housing and connected to said housing in order to allow the two-phase fluid to circulate.

However, immersing the electrical storage cells in a fluid, in particular a dielectric fluid, does not allow homogeneous cooling of the cells.

The aim of the invention is to provide an alternative for cooling battery elements by overcoming the aforementioned problems of the prior art, by proposing a cooling device that lowers and homogenizes the temperature of the battery element, thus optimizing the lifetime and the performance of such a battery element, in particular an electrical storage system for a motor vehicle.

The invention also relates to a method for cooling a plurality of battery elements of an electrical storage system implementing the cooling device of the present invention.

A device of the present invention is a device for cooling a plurality of battery elements of a motor vehicle.

According to the present invention, the cooling device comprises a first housing and a plurality of stages of battery elements disposed in the first housing. Each stage of battery elements is equipped with a condenser provided with a coolant circuit. The condenser is associated with at least one dielectric fluid circuit that is configured to project a dielectric fluid onto the battery elements of the same stage and a recovery tank for the dielectric fluid that is common to the plurality of stages of battery elements. The cooling device comprises means for recirculating the dielectric fluid that are provided with a pump and that connect the recovery tank to a dielectric fluid inlet that the dielectric fluid circuit comprises.

The battery elements are arranged as a tiered stack, forming a plurality of stages of battery elements, and each battery element stage can comprise one or more battery element(s). In this way, the cooling device can comprise a plurality of battery elements distributed in a plurality of columns of battery elements and a plurality of stages, with each stage of battery elements being provided with a condenser and a dielectric fluid circuit capable of spraying the electrical fluid onto the battery elements of the corresponding stage. According to the invention, and irrespective of the configuration and the number of stages and of battery elements per stage, the device is configured so that a recovery tank is capable of receiving the dielectric fluid sprayed onto each of the stages of a given set of battery elements, and so that a pump is capable of supplying dielectric fluid originating from the recovery tank to all the dielectric fluid circuits allowing the given set of battery elements to be sprayed.

The cooling device advantageously comprises at least any one of the following technical features, taken individually or in combination:

a plate is disposed in the first housing to support each of the stages of battery elements, with each plate being configured to allow gravity flow of the dielectric fluid to the recovery tank. This configuration can be made up of one or more hole(s) produced in the plate or even can be made up of a passage arranged between the plate and the walls defining the first housing, with the dimensions of the plate then being smaller than that of the first housing in the plane of the relevant plate;
at least one plate, in particular the lower plate, on which a stage of battery elements, in particular the lower stage, rests, is perforated with a plurality of orifices in order to allow the dielectric fluid to be filtered toward the recovery tank;
the condenser is arranged so as to have a plane that is inclined relative to a horizontal position of the cooling device once mounted in a vehicle. Advantageously, the main wall of the condenser has a plane that is inclined relative to a horizontal position of the cooling device once mounted in a vehicle. Thus, the flow of the droplets of dielectric fluid formed by condensation on a face of said condenser can be controlled more easily;
the condenser comprises at least one main wall provided with the dielectric fluid inlet as well as a coolant inlet and a coolant outlet, between which the coolant circuit extends;
the same side of the main wall is equipped with the dielectric fluid inlet, the coolant inlet and the coolant outlet, in order to facilitate a connection with means for supplying the main wall with coolant and dielectric fluid;
the coolant circuit extends inside a thickness of the main wall, and/or the dielectric fluid circuit is formed in the thickness of the condenser. A circuit extending inside a thickness or formed in the thickness is equally understood to be a configuration with ducts hollowed out of the material and a configuration with shells applied against each other to form a wall of the condenser, with at least one of the shells being stamped to form a channel of said circuit;
the dielectric fluid circuit is at least partially formed by a duct produced separately from the condenser and added onto a face of the condenser, which face is turned toward a chamber for receiving at least one battery element. The separate production of the dielectric fluid circuit allows the condenser and the coolant circuit to be produced from different materials and/or with different thicknesses, which ensures the pressure resistance of the dielectric fluid circuit, without any risk of condenser leaks. In particular, the electrical fluid circuit can be made up of an aluminum tube added onto the condenser. Advantageously, the duct is fluidly connected to at least one dielectric fluid inlet positioned on the main wall of the condenser, which itself is also equipped with the coolant inlet and outlet. Thus, the connection with fluid supply means is facilitated;
the condenser comprises a plurality of secondary walls, including a first lateral secondary wall provided at a first longitudinal end of the main wall, a second lateral secondary wall provided at a second longitudinal end of the main wall and an intermediate secondary wall that is interposed between the lateral secondary walls, with the intermediate secondary wall helping to define, with part of the main wall and one of the lateral secondary walls, a chamber for receiving a battery element of one of the stages of battery elements;
the dielectric fluid circuit extends into the thickness of, or is applied against, the main wall and at least one secondary wall;
at least one secondary wall is equipped with a plurality of circulation branches for the dielectric fluid, so as to spray the dielectric fluid over different heights of the battery elements;
the dielectric fluid circuit is equipped with a plurality of spray nozzles, with each spray nozzle being oriented toward one of the battery elements;
each battery element comprises at least one electrical storage cell, with the one or more electrical storage cell(s) being directly opposite the walls of the condenser. In this way, the projection of the dielectric fluid is guided directly onto the storage cells, and the cooling by means of the dielectric fluid can be more efficient, at least for the storage cells that receive the dielectric fluid directly;
each battery element comprises a second housing accommodating at least one electrical storage cell, with the second housing extending between the one or more storage cell(s) and the walls of the condenser. In this way, the projection of the dielectric fluid is guided directly onto the second housing, and the cooling of the storage cells by means of the dielectric fluid can be more homogeneous for all the storage cells.

The present invention also relates to a method for implementing such a cooling device, the method comprising a step of spraying dielectric fluid toward stages of battery elements, a step of evaporating dielectric fluid in contact with the battery elements, a step of condensing dielectric fluid in contact with the condenser, a step of recovering dielectric fluid condensed at each stage inside the recovery tank common to the plurality of stages and a step of recirculating dielectric fluid to each dielectric fluid circuit equipping a corresponding stage of battery elements.

Further features and advantages of the invention will become more clearly apparent from the following description, on the one hand, and from several embodiments, which are provided for information and non-limiting purposes with reference to the accompanying schematic drawings, on the other hand, in which drawings:

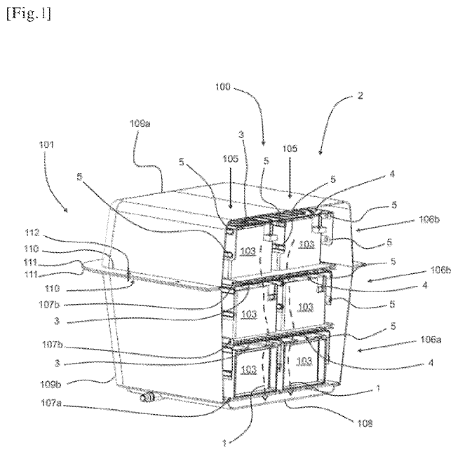

FIG. 1 illustrates a perspective view of a section of an electrical storage system equipped with a device for cooling battery elements according to the present invention;

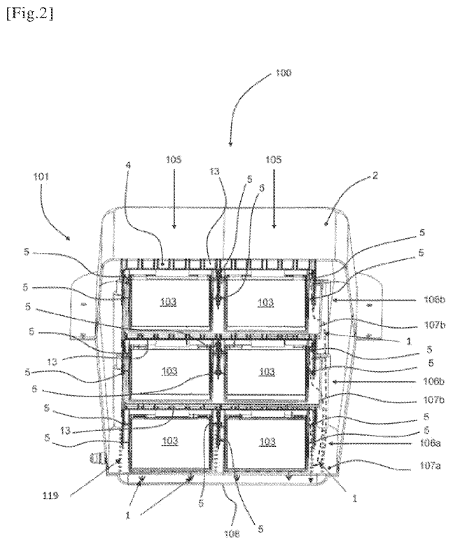

FIG. 2 illustrates a front view of the section of the storage system shown in FIG. 1;

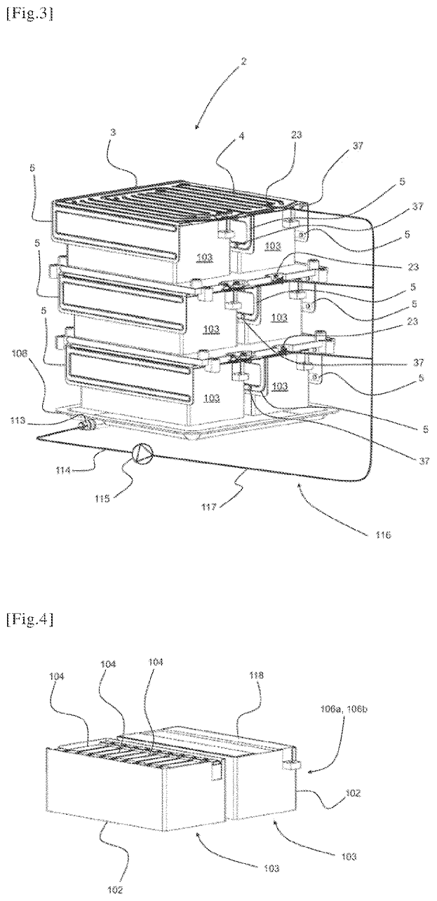

FIG. 3 illustrates a partial perspective view of the storage system illustrated in FIGS. 1 and 2, with a first housing particularly being removed in order to clearly show the cooling device and to schematically illustrate a recirculation duct and a pump of the cooling device;

FIG. 4 illustrates a perspective view of a first variant of battery elements capable of being cooled by the cooling device shown in FIGS. 1 to 3;

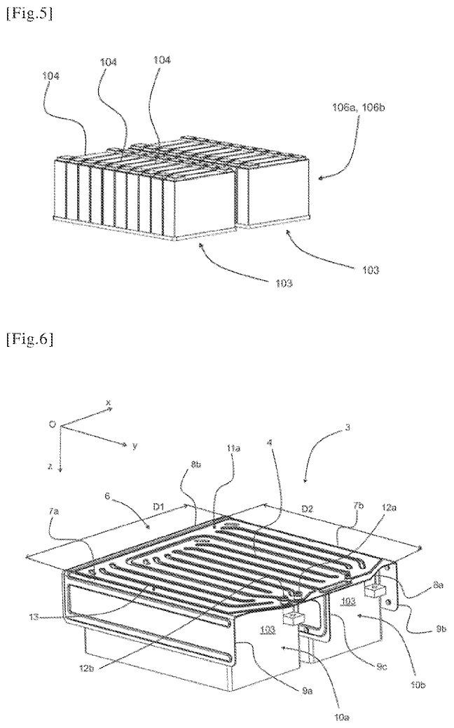

FIG. 5 illustrates a perspective view of a second variant of battery elements capable of being cooled by the cooling device shown in FIGS. 1 to 3;

FIG. 6 illustrates a perspective view of a condenser forming an alternative embodiment of the cooling device shown in FIGS. 1 to 3 and intended to cool the battery elements illustrated in FIG. 4 or 5;

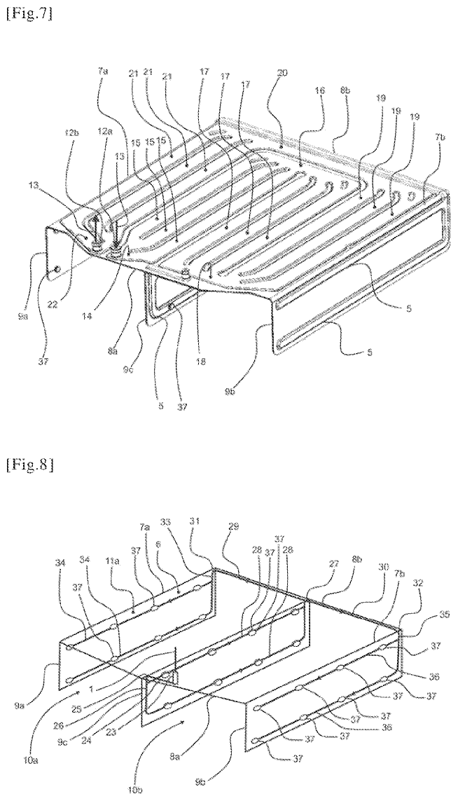

FIG. 7 illustrates a perspective view of the condenser illustrated in FIG. 6;

FIG. 8 illustrates a schematic view of the condenser illustrated in FIGS. 6 and 7, in order to show the dielectric fluid circulation channels present in the thickness of the condenser;

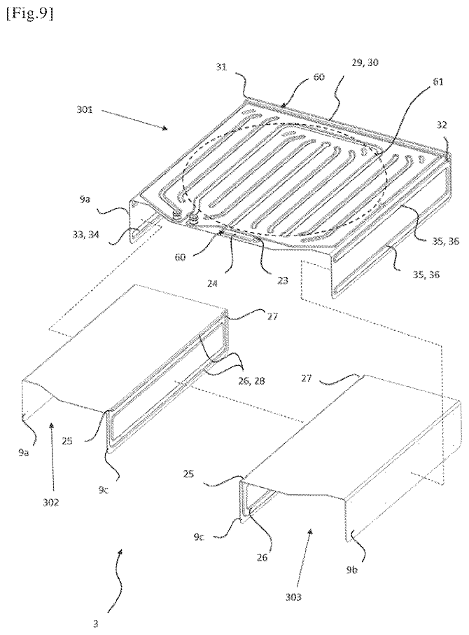

FIG. 9 illustrates an exploded perspective view of the condenser illustrated in FIGS. 6 to 8;

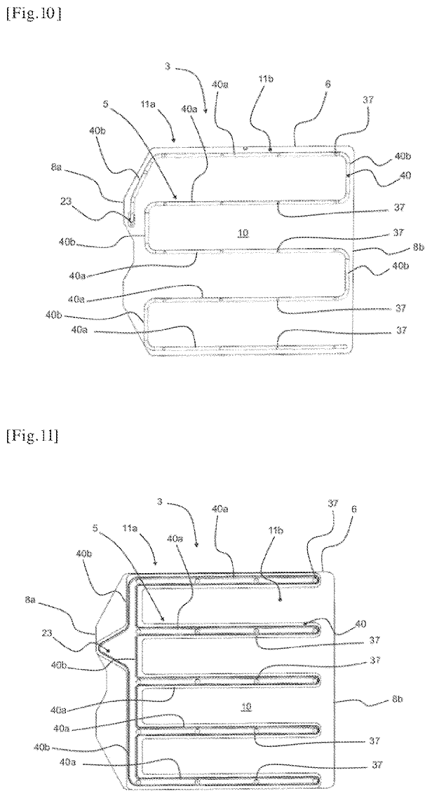

FIG. 10 illustrates an alternative embodiment of the condenser illustrated in FIGS. 6 to 8, with a dielectric fluid circuit produced separately and added onto the condenser;

FIG. 11 illustrates another alternative embodiment of the condenser illustrated in FIGS. 6 to 8, with a dielectric fluid circuit produced separately and added onto the condenser;

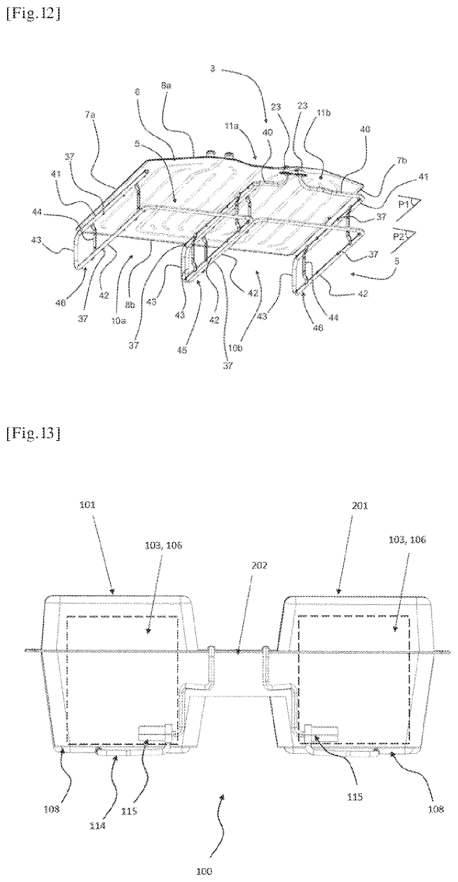

FIG. 12 illustrates another alternative embodiment of the condenser illustrated in FIGS. 6 to 8, with a dielectric fluid circuit produced separately and added onto the condenser;

FIG. 13 illustrates another embodiment of an electrical storage device comprising two cooling devices according to the present invention.

The features, the alternatives and the various embodiments of the invention can be combined with one another, in various combinations, provided that they are not mutually incompatible or exclusive. In particular, alternative embodiments of the invention can be contemplated that only comprise a selection of features that are described hereafter independently of the other described features, if this selection of features is sufficient to provide a technical advantage or to differentiate the invention from the prior art.

In particular, all the alternative embodiments and all the described embodiments can be combined together if there are no technical obstacles to this combination.

In the figures, elements common to several figures keep the same reference sign.

In FIG. 1, an electrically powered or hybrid motor vehicle is provided with an electrical storage system 100 intended to supply electrical energy to an electric motor equipping the motor vehicle for the movement thereof. The electrical storage system 100 comprises a first housing 101 that accommodates a plurality of battery elements 103.

The first housing 101 comprises two half-shells 109a, 109b, including a first shell 109a and a second shell 109b, which are arranged as a cup and which are joined together by means of their rims 110. To this end, each rim 110 is provided with a lip 111, with the lip 111 of the first shell 109a being fixed to the lip 111 of the second shell 109b by means of reversible junction means 112, of the screwing type or of a similar type.

The battery elements 103 are shaped as a parallelepiped and are arranged relative to each other by being disposed as a tiered stack. More specifically, the battery elements 103 are stacked on top of each other in a plurality of columns 105 while being distributed over several stages 106a, 106b. In other words, each stage 106a, 106b of battery elements 103 preferably comprises a plurality of battery elements 103 as a function of the number of columns 105, with it being understood that the number of stages and of columns of battery elements varies as a function of the permitted spatial requirement of the first housing and as a function of the amount of electrical energy to be stored. In the same stage 106a, 106b of battery elements 103, said battery elements are disposed side-by-side and each stage 106a, 106b of battery elements 103 is supported by a plate 107a, 107b, on which the battery elements 103 rest.

According to the illustrated example, there are six battery elements 103 and they are distributed over two columns 105 and three stages 106a, 106b, with each column 105 comprising three battery elements 103 and each stage 106a, 106b comprising two battery elements 103. As stated above, the number of columns 105 and the number of stages 106a, 106b are likely to be different from the illustrated example, in particular by being higher.

As they operate, the battery elements 103 tend to heat up. Furthermore, the motor vehicle is equipped with a device 2 for cooling the battery elements 103. Advantageously, the cooling device 2 of the present invention is capable of simultaneously cooling each of the stages 106a, 106b of battery elements 103. To this end, the cooling device 2 associates at least one dielectric fluid circuit 5, which is arranged to spray a dielectric fluid 1 onto a corresponding stage 106a, 106b of battery elements 103, and at least one condenser 3 accommodating a coolant circuit 4, which is designed to transition the dielectric fluid 1, which is sprayed onto the battery elements 103 and is converted into vapor under the effect of heat that is released by the battery elements, from a vapor state to a liquid state.

The coolant 4 particularly can be made up of a cooling liquid or a refrigerant fluid, and, for example, can be made up of glycol water, R134a or 1234yf, or even CO2, with this list by no means being limiting.

With respect to the dielectric fluid, it is selected as a function of its phase transition point. By way of an example, the fluid selected herein must have an evaporation temperature at atmospheric pressure that is higher than 32, 33 or 34 degrees Celsius and a condensation temperature that is lower than 31, 30 or 29 degrees Celsius.

In other words, the dielectric fluid sprayed in liquid form onto the battery elements of a given stage recovers calories released by these battery elements and is thus converted into vapor. The vapor rises in order to come into contact with the condenser 3, inside which a coolant can circulate, and the condenser recovers the calories previously stored by the dielectric fluid until it is liquefied. In liquid form, and as droplets, the dielectric fluid drops into the first housing under the effect of gravity.

More specifically, the cooling device of the present invention comprises as many dielectric fluid circuits 5 as there are stages 106a, 106b of battery elements 103 housed by the first housing 101. Even more specifically, the cooling device 2 of the present invention advantageously comprises as many condensers 3 as there are stages 106a, 106b of battery elements 103 housed by the first housing 101. Moreover, each dielectric fluid circuit 5 is advantageously associated with a corresponding condenser 3 in order to optimize condensation of the dielectric fluid 1 and, subsequently, cooling of the battery elements 103, stage-by-stage, with such an association being as compact as possible inside the first housing 101 that defines a desired confined space that is as small as possible.

As is more specifically shown in FIG. 2, the cooling device 2 comprises the first housing 101, a bottom of which forms a recovery tank 108 for the dielectric fluid 1 that flows under the effect of gravity from a stage 106a, 106b of battery elements 103 to a lower stage 106a, 106b of battery elements 103. More specifically, the recovery tank is used to recover dielectric fluid that has been vaporized by each condenser. To this end, each plate supporting the stages of battery elements is configured to allow fluid to move under the effect of gravity toward the recovery tank.

A lower plate 107a can be distinguished from among the plates 107a, 107b on which a respective stage 106a, 106b of battery elements 103 rests, on which lower plate 107a a lower stage 106a of battery elements 103 rests. It is understood that the lower stage 106a is the stage of the stages 106a, 106b that does not overhang any other stage and that thus is the lowest of the stages 106a, 106b of the tiered stack of battery elements 103 described above, with reference to a vertical arrangement and to the gravity flow direction of the dielectric fluid in liquid form. It is also understood that the upper stages 106b of battery elements 103 supported by a corresponding upper plate 107b overhang at least one other stage 106a, 106b of battery elements 103.

Once this distinction is made, it should be noted that the lower plate 107a is perforated with a plurality of orifices 119 allowing the dielectric fluid to flow through it toward the recovery tank. The orifices 119 are designed to allow an operation that involves filtering the dielectric fluid before it enters the recovery tank. In order to enable an efficient filtering operation, the lower plate 107a is designed to be in contact, over its perimeter, with the walls defining the first housing.

It also should be noted that the upper plates 107b have a solid, non-perforated surface, and that they are designed to form a peripheral passage between the perimeters of the corresponding plate and the walls defining the first housing. It is understood that these upper plates 107b overhang a lower stage and thus a condenser and that it is not desirable for the dielectric fluid in liquid form to flow over the upper face of the condenser, i.e. over the face opposite the upper plate. Therefore, it is noteworthy that according to the invention, and as illustrated by dashed lines in FIG. 2, the dielectric fluid in liquid form is discharged via the sides of the plate in the upper stages by falling onto the lower plate, with the dielectric fluid being able to pass into the recovery tank via the orifices 119 when this fluid stagnates on the lower plate 107a.

In an alternative embodiment, not shown, provision can be made for each, or at least some, of the upper plates to be perforated as well; advantageously, the condensers that these perforated plates overhang are arranged so as to have a plane that is inclined relative to the plane of the corresponding plate. Therefore, the water flowing through the upper plates via the perforations is not able to stagnate between the condenser and the corresponding upper plate and can flow over the sides in order to fall into the recovery tank under the effect of gravity.

With reference to FIG. 3, the recovery tank 108 is provided with a discharge pipe 113 for the dielectric fluid 1 recovered inside the recovery tank 108, with the discharge pipe 113 being in fluid communication with a recirculation duct 114 for the dielectric fluid 1. The recirculation duct 114 is equipped with a pump 115 for conveying the dielectric fluid 1 to each of the dielectric fluid inlets 23 equipping a condenser. Thus, the pump 115, which is common to each of the stages of battery elements of the cooling device 2, is capable of supplying dielectric fluid 1 to all the dielectric fluid circuits 5 that the cooling device 2 comprises, which is advantageous in terms of the production cost. It is understood that a distributor, not shown in the figure, is capable of supplying dielectric fluid 1 to all the dielectric fluid circuits 5 that the cooling device 2 comprises and that equip a respective stage 106a, 106b of battery elements 103.

As illustrated, it is noteworthy that the dielectric fluid inlets 23 are all arranged on the same side of each condenser 3, in order to facilitate the distribution of the dielectric fluid recovered in the common recovery tank in each of the dielectric fluid inlets.

Each dielectric fluid circuit 5 is provided with at least one spray nozzle 37, which is capable of spraying the dielectric fluid 1 in the liquid state toward the battery elements 103 in order to cool them. It is thus understood that the dielectric fluid 1 passes through a circulation loop 116 comprising the recovery tank 108 for the dielectric fluid 1 in the liquid state, the recirculation duct 114 for the dielectric fluid 1 equipped with the pump 115 that supplies dielectric fluid 1, by means of recirculation means 117 and jointly with each dielectric fluid circuit 5 equipping a stage 106a, 106b of battery elements 103, to the spray nozzles 37 of the dielectric fluid circuits 5 spraying the battery elements 103, which dielectric fluid vaporizes on contact with them and then liquefies in contact with the condensers 3 in order to drip inside a common recovery tank 108 under the effect of gravity. The advantageous nature of the present invention can be understood, which particularly lies in sharing the stated cooling means for each stage 106a, 106b of the tiered stack arrangement of the battery elements 103.

FIG. 4 shows a stage 106a, 106b of battery elements 103 according to a first alternative embodiment. Each battery element 103 comprises a second housing 102 that accommodates a plurality of electrical storage cells 104. The second housing 102 comprises a cover 118, which is removed from one of the second housings 102 in order to reveal the electrical storage cells 104. In this first alternative embodiment, the dielectric fluid sprayed via the nozzles equipping the dielectric fluid circuit comes into contact with the second housing and vaporizes under the effect of the heat released by this second housing. The cooling of this second housing causes a temperature drop in the enclosure in which the electrical storage cells are housed, and therefore causes a temperature drop in the cells themselves.

FIG. 5 shows a stage 106a, 106b of battery elements 103 according to a second alternative embodiment. Each battery element 103 only comprises a plurality of electrical storage cells 104. In this second alternative embodiment, in which the electrical storage cells are directly opposite the condenser, the dielectric fluid sprayed via the nozzles equipping the dielectric fluid circuit comes into direct contact with the electrical storage cells and vaporizes under the effect of the heat released by each of these cells.

It is understood that each electrical storage cell 104 is the functional unit of the battery element 103 that at least partially supplies the electric motor with the electrical energy that it requires. The electrical storage cell 104 is a lithium-ion cell or similar, for example.

In FIG. 6, the condenser 3 is shown in an orthonormal coordinate system Oxyz that comprises a longitudinal axis Ox, a lateral axis Oy and a transverse axis Oz. The condenser 3 comprises a main wall 6 that extends inside a plane parallel to the plane Oxy. The main wall 6 is substantially arranged as a quadrilateral that comprises two longitudinal ends of the main wall 7a, 7b, opposite each other and provided at a first distance D1 from each other, and two lateral ends of the main wall 8a, 8b, opposite each other and provided at a second distance D2 from each other.

According to the illustrated alternative embodiment, the condenser 3 also comprises three secondary walls 9a, 9b, 9e that respectively extend in a plane parallel to the plane Oyz. The following can be distinguished from among the three secondary walls 9a, 9b, 9c: a first lateral secondary wall 9a that is provided at a first longitudinal end of the main wall 7a, a second lateral secondary wall 9b that is provided at a second longitudinal end of the main wall 7b and an intermediate secondary wall 9c that is interposed between the lateral secondary walls 9a, 9b, in this case by being disposed at an equal distance from the first lateral secondary wall 9a and from the second lateral secondary wall 9b.

The first lateral secondary wall 9a and the intermediate secondary wall 9C define, with a portion of the main wall 6, a first chamber 10a that is intended to receive a first battery element 103. The second lateral secondary wall 9b and the intermediate secondary wall 9c define, with another portion of the main wall 6, a second chamber 10b that is intended to receive a second battery element 103.

The main wall 6 houses the coolant circuit 4 that winds inside the main wall 6, above the first chamber 10a and above the second chamber 10b. According to one embodiment, the coolant circuit 4 is provided in a thickness of the main wall 6. According to another embodiment, the main wall 6 is formed by two shells affixed against each other, with at least one shell comprising a boss that defines a cavity forming the coolant circuit 4. In this case, the coolant circuit 4 is provided in relief on at least one of the shells.

The main wall 6 comprises a first face 11a, the upper face in FIG. 6, which is provided with a coolant inlet 12a and a coolant outlet 12b. The coolant inlet 12a is provided to allow coolant 13 to enter inside the coolant circuit 4, whereas the coolant outlet 12b is provided to allow the coolant 13 to discharge out of the coolant circuit 4. The coolant 13 is carbon dioxide or similar, for example. It is understood that from a flow of coolant 13 inside the coolant circuit 4, the coolant 13 cools the main wall 6 in order to keep it at a temperature that is below a condensation temperature of the dielectric fluid 1, which ensures, upon contact therewith, that the dielectric fluid 1 transitions to the liquid state.

As is more clearly shown in FIG. 7, the coolant inlet 12a and the coolant outlet 12b are provided in the vicinity of a first lateral end of the main wall 8a and the coolant circuit 4 extends from the coolant inlet 12a to the coolant outlet 12b. The coolant circuit 4 comprises, for example, a plurality of coolant circulation branches 15, 17, 19, 21 that are provided parallel to each other. Thus, according to the illustrated example, the coolant inlet 12a is in fluid communication with a distributor 14 that supplies three first coolant circulation branches 15 that are parallel to each other. These three first coolant circulation branches 15 emerge inside a first manifold 16 that is provided in the vicinity of a second lateral end of the main wall 8b. Furthermore, the coolant 13 travels substantially the second distance D2 inside the first coolant circulation branches 15. The first manifold 16 is in fluid communication with three second coolant circulation branches 17 that are provided parallel to each other. The three second coolant circulation branches 17 extend from the first manifold 16 to a second manifold 18 that is provided in the vicinity of the first lateral end of the main wall 8a. Furthermore, the coolant 13 again travels substantially the second distance D2 inside the second coolant circulation branches 17. The second manifold 18 is in fluid communication with three third coolant circulation branches 19 that are provided parallel to each other, with one of the third coolant circulation branches 19 bordering the second longitudinal end of the main wall 7b. The three third coolant circulation branches 19 extend from the second manifold 18 to a third manifold 20 that is provided in the vicinity of the second lateral end of the main wall 8b and that extends along the second lateral end of the main wall 8b to the first longitudinal end of the main wall 7a. Furthermore, the coolant 13 again travels substantially the second distance D2 inside the third coolant circulation branches 19. Furthermore, the coolant 13 travels substantially the first distance D1 inside the third manifold 20. The third manifold 20 is in fluid communication with three fourth coolant circulation branches 21 that are provided parallel to each other, with one of the fourth circulation branches of the coolant 21 bordering the first longitudinal end of the main wall 7a. The three fourth coolant circulation branches 21 extend from the third manifold 20 to a fourth manifold 22 that is provided with the coolant outlet 12b. It is understood that the number of coolant circulation branches 15, 17, 19, 21 disposed between two manifolds 16, 18, 20 or between a manifold 16, 18, 20 and the distributor 14, as well as the number of manifolds 16, 18, 20, are likely to be different from those previously stated.

The fact that the coolant 13 travels the second distance D2 and the first distance D1 several times allows the entire surface of the main wall 6 to be cooled and, subsequently, allows the dielectric fluid 1 to be cooled that comes into contact with the main wall 6 after it is vaporized in contact with the battery elements 103.

It is noteworthy that the main wall and the various coolant circulation branches that are formed therein are configured so that the coolant circuit 4 is arranged in a central zone 61 of the main wall 6.

Following the description of the coolant circuit 4, the dielectric fluid circuit 5 will now be described, which is illustrated herein according to various alternative embodiments.

As will be described hereafter, and further to the aforementioned description of the position of the coolant circuit in a central zone 61, the dielectric fluid circuit 5 is arranged in the condenser so as to leave this central zone formed in the main wall clear, either by extending over walls of the condenser other than the main wall, and/or by extending over a peripheral zone 60 of the main wall.

In a first alternative embodiment, particularly illustrated in FIGS. 6 to 9, the dielectric fluid circuit 5 is produced in the thickness of the condenser, i.e. by being integrated in the walls 6, 9a, 9b, 9c forming the condenser 3.

In particular, the circuit can be produced by stamped portions that are respectively formed in either one of two shells that each form walls once they are assembled together. In this context, and according to an embodiment that is more clearly shown in the exploded view of FIG. 9, the walls 6, 9a, 9b, 9c can be formed from three shells 301, 302, 303, in particular metal shells shaped as a U, including a first shell 301 accommodating a second shell 302 and a third shell 303, with the coolant circuit 4 and the dielectric fluid circuit 5 being provided between the shells 301, 302, 303, in particular from a stamp of one of said shells. The shells 301, 302, 303 are brazed or welded together, for example. It is understood that, in this alternative embodiment, the second shell and the third shell are designed to each define a chamber for receiving an electrical storage element.

The dielectric fluid circuit particularly can be described with reference to FIGS. 8 and 9, which schematically illustrate this circuit in an exploded view.

The first face 11a of the main wall 6 is provided with a dielectric fluid inlet 23 that is provided in the vicinity of the first lateral end of the main wall 8a. The dielectric fluid inlet 23 allows dielectric fluid 1 to enter inside the dielectric fluid circuit 5. The dielectric fluid inlet 23 is in fluid communication with a first dielectric fluid channel 24 that runs along the first lateral end of the main wall 8a between the dielectric fluid inlet 23 and a first dielectric fluid circulation point 25 that is located in line with the intermediate secondary wall 9c.

More specifically, the first dielectric fluid channel 24 can be formed by a stamped portion formed in the first shell 301 supporting the dielectric fluid inlet and by a flat surface of the second or third shell. Furthermore, the first circulation point can be formed by two opposite stamped portions respectively formed in the walls of the second and third shells helping to form the intermediate secondary wall.

The first dielectric fluid circulation point 25 is in fluid communication with a second dielectric fluid channel 26 that extends inside the intermediate secondary wall 9c to a second dielectric fluid circulation point 27 located in the vicinity of the second lateral end of the main wall 8b. The second dielectric fluid channel 26 comprises two first dielectric fluid circulation branches 28 that are parallel to each other.

The second dielectric fluid circulation point 27 is in fluid communication with a third dielectric fluid channel 29 and a fourth dielectric fluid channel 30 that both extend along the second lateral end of the main wall 8b.

The third dielectric fluid channel 29 extends between the second dielectric fluid circulation point 27 and a fourth dielectric fluid circulation point 31 that is located in line with the first lateral secondary wall 9a.

The fourth dielectric fluid circulation point 31 is in fluid communication with a fifth dielectric fluid channel 33 that extends inside the first lateral secondary wall 9a and that comprises two second dielectric fluid circulation branches 34 that are parallel to each other. The second dielectric fluid circulation branches 34 extend from the second lateral end of the main wall 8b to the first lateral end of the main wall 8b.

The fourth dielectric fluid channel 30 extends between the second dielectric fluid circulation point 27 and a fifth dielectric fluid circulation point 32 that is in line with the second lateral secondary wall 9b.

Inside the dielectric fluid circulation channels the dielectric fluid 1 travels substantially the second distance D2, which allows the dielectric fluid to be projected over the whole of a first dimension, in this case the length, of the battery elements 103. Moreover, the fact that the circulation channels comprise a plurality of dielectric fluid circulation branches enables the dielectric fluid to be sprayed over different heights of the battery elements, respectively for a second dimension of the battery elements parallel to the stacking direction of the stages, and therefore allows the operation for cooling the considered battery element to be homogenized.

The fifth dielectric fluid circulation point 32 is in fluid communication with a sixth dielectric fluid channel 35 that extends inside the second lateral secondary wall 9b and that comprises two third dielectric fluid circulation branches 36 that are parallel to each other. The third dielectric fluid circulation branches 36 extend from the second lateral end of the main wall 8b to the first lateral end of the main wall 8b. Thus, the dielectric fluid 1 travels substantially the second distance D2 inside the sixth dielectric fluid channel 35.

Each dielectric fluid circulation branch 28, 34, 36 is equipped with a plurality of spray nozzles 37 for spraying dielectric fluid 1 toward the chamber 10a, 10b bordered by the secondary walls 9a, 9b, 9c. According to the illustrated example, each dielectric fluid circulation branch 28, 34, 36 is equipped with four spray nozzles 37. The number of spray nozzles 37 equipping a dielectric fluid circulation branch 28, 34, 36 is likely to be different.

It should be noted that the first dielectric fluid circulation branches 28 are provided with a number of spray nozzles 37 that is equivalent to twice the number of spray nozzles 37 that respectively equip the second dielectric fluid circulation branches 34 and the third dielectric fluid circulation branches 36, for spraying dielectric fluid 1 toward the first chamber 10a and toward the second chamber 10b, due to the fact that the intermediate secondary wall 9c, which is equipped with the first dielectric fluid circulation branches 28, borders the two chambers 10a, 10b. It is understood that the spray nozzles 37 equipping the second dielectric fluid circulation branches 34 are intended to spray the dielectric fluid 1 toward the first chamber 10a and that the spray nozzles 37 equipping the third dielectric fluid circulation branches 36 are intended to spray the dielectric fluid 1 toward the second chamber 10b.

According to the previously described alternative embodiment, the dielectric fluid circuit 5 is produced in the thickness of the main wall 6 of the condenser 3 and in the thickness of the secondary walls 9a, 9b, 9c of the condenser 3.

The description and the corresponding figures, in particular FIG. 9, clearly illustrate the feature whereby the coolant circuit 4 is only provided in the thickness of the main wall 6, and in a central zone 61, whereas the dielectric fluid circuit 5 is configured to clear this central zone and not undermine the action of the condenser on the vaporized dielectric fluid extends. In particular, the dielectric fluid circuit can extend into the thickness of one and/or the other of the secondary walls 9a, 9, 9c, and it can extend at the border of the main wall, in a peripheral zone 60.

According to the alternative embodiments described hereafter, the condenser 3 does not have secondary walls, such that the condenser 3 is mainly formed by a main wall 6.

According to the alternative embodiments illustrated in FIGS. 10 and 11, the dielectric fluid circuit 5 is produced by a duct separate from the condenser and particularly added onto a second face 11b of the main wall 6, with this second face 11b being opposite the first face 11a and bordering a single chamber 10 for receiving a plurality of battery elements 103. In this case, the dielectric fluid circuit 5 is produced, for example, from an aluminum tube 40 that is brazed and/or welded onto the second face 11b of the main wall 6 of the condenser 3. The tube 40 is provided with a plurality of spray nozzles 37 oriented toward the single chamber 10. The tube 40 is arranged, for example, as a flat coil that comprises first tube portions 40a parallel to the longitudinal ends of the main wall 7a, 7b and second tube portions 40b running along the lateral ends of the main wall 8a, 8b, with at least one first tube portion 40a being interposed between two second tube portions 40b and at least one second tube portion 40b being interposed between two first tube portions 40a.

In FIG. 10, the second tube portions 40b are alternately provided in the vicinity of the first lateral end of the main wall 8a and of the second lateral end of the main wall 8b.

In FIG. 11, the second tube portions 40b are provided in the vicinity of the first lateral end of the main wall 8a.

According to these latter two embodiments, the dielectric fluid 1 is mainly projected onto upper surfaces of the battery elements 103 disposed opposite the second face 11b of the main wall 6. However, some spray nozzles 37 are oriented, for example, to project the dielectric fluid onto lateral walls of the battery elements that are substantially orthogonal to the main wall 6.

According to another alternative embodiment illustrated in FIG. 12, the condenser 3 is equipped with two dielectric fluid circuits 5 that extend away from the second face 11b of the main wall 6, opposite the first face 11a. Each dielectric fluid circuit 5 is produced, for example, from a tube 40 that partially extends inside two planes of tubes P1, P2. Thus, each dielectric fluid circuit 5 comprises at least one first circuit portion 41 that extends inside a first plane P1 and a second circuit portion 42 extends inside a second plane P2, the first plane P1 being interposed between the main plate 6 and the second plane P2, with the distances provided between the main plate 6 and the first plane P1, on the one hand, and between the first plane P1 and the second plane P2, on the other hand, being non-zero. The first circuit portion 41 and the second circuit portion 42 of the same dielectric fluid circuit 5 are connected together by means of at least one third circuit portion 43 that extends along an axis orthogonal to the first plane P1 and to the second plane P2. Mechanical reinforcements 44 extend between the first circuit portion 41 and the second circuit portion 42 of the same dielectric fluid circuit 5 in order to ensure the robustness of each dielectric fluid circuit 5. These arrangements are such that each tube 40 is arranged as a coil that extends into a volume at least bordered by the main plate 6 and the second plane P2. The tube 40 is provided with a plurality of spray nozzles 37 oriented toward the first chamber 10a or the second chamber 10b that are at least partially defined by an intermediate arrangement 45 of an element of a first circuit portion 41 and of an element of a second circuit portion 42 stacked on each other, with the intermediate arrangement 45 being interposed between two respective lateral arrangements 46 of an element of a first circuit portion 41 and of an element of a second circuit portion 42 stacked on each other.

These arrangements are such that the dielectric fluid circuits arranged thus are capable of spraying the dielectric fluid onto the lateral walls of the battery elements 103.

FIG. 13 illustrates an embodiment of an electrical storage device for which two cooling devices are provided. In accordance with the previous description, each cooling device is associated with a portion of the electrical storage system 100 comprising a housing 101, 201 that accommodates a plurality of battery elements 103 arranged in stages 106, and each cooling device comprises a recovery tank arranged at the bottom of the corresponding housing in order to recover the dielectric fluid originally sprayed onto a plurality of stages of battery elements.

In the illustrated example, a first housing 101 and a second housing 201 are arranged side-by-side with a connection portion 202 that has a clearance zone in order to conform to a particular arrangement of a motor vehicle, with this by no means being limiting. The example of FIG. 13 is particularly advantageous in that it explains that an electrical storage device can comprise a plurality of recovery tanks and a plurality of pumps without departing from the scope of the invention, where each recovery tank and each associated pump are arranged to recover the electric fluid sprayed onto a plurality of battery elements stacked on top of each other and above the considered recovery tank.

1. A cooling device for a plurality of battery elements of a motor vehicle, the cooling device comprising:
a first housing; and
a plurality of stages of battery elements disposed in the first housing,
each stage of battery elements being equipped with a condenser provided with a coolant circuit, with the condenser being associated with at least one dielectric fluid circuit that is configured to project a dielectric fluid onto the battery elements of the same stage and a recovery tank for the dielectric fluid that is common to the plurality of stages of battery elements; and
means for recirculating the dielectric fluid that are provided with a pump and that connect the recovery tank to at least one dielectric fluid inlet that each of the dielectric fluid circuits comprises.

2. The cooling device as claimed in claim 1, wherein a plate is disposed in the first housing to support each of the stages of battery elements, with each plate being configured to allow gravity flow of the dielectric fluid to the recovery tank.

3. The cooling device as claimed in claim 1, wherein at least one plate on which a stage of battery elements rests is perforated with a plurality of orifices to allow the dielectric fluid to filter toward the recovery tank.

4. The cooling device as claimed in claim 1, wherein the dielectric fluid circuit is formed in the thickness of the condenser.

5. The cooling device as claimed in claim 1, wherein the dielectric fluid circuit is formed by a duct produced separately from the condenser and added onto a face of the condenser, which face is turned toward a chamber for receiving at least one battery element.

6. The cooling device as claimed in claim 1, wherein the condenser comprises at least one main wall provided with the dielectric fluid inlet as well as a coolant inlet and a coolant outlet, between which the coolant circuit extends, the condenser further comprising a plurality of secondary walls forming a projection from the main wall, including a first lateral secondary wall provided at a first longitudinal end of the main wall, a second lateral secondary wall provided at a second longitudinal end of the main wall and an intermediate secondary wall that is interposed between the lateral secondary walls, with the intermediate secondary wall helping to define, with part of the main wall and one of the lateral secondary walls, a chamber for receiving a battery element of one of the stages of battery elements.

7. The cooling device as claimed in claim 1, wherein the dielectric fluid circuit is equipped with a plurality of spray nozzles, with each spray nozzle being oriented toward one of the battery elements.

8. The cooling device as claimed in claim 1, wherein each battery element comprises at least one electrical storage cell, the one or more electrical storage cell(s) being directly opposite the walls of the condenser.

9. The cooling device as claimed in claim 1, wherein each battery element comprises a second housing accommodating at least one electrical storage cell, the second housing extending between the one or more electrical storage cell(s) and the walls of the condenser.

10. A method for implementing a cooling device as claimed in claim 1, said method comprising:
spraying dielectric fluid toward the stages of battery elements;
evaporating dielectric fluid in contact with the battery elements;
condensing dielectric fluid in contact with the condenser;
recovering dielectric fluid condensed at each stage inside the recovery tank common to the plurality of stages; and
recirculating dielectric fluid to each dielectric fluid circuit equipping a corresponding stage of battery elements.
